(19) United States
(12) Patent Application Publication
(10) Pub. No.: US 2006/0133499 A1
(43) Pub. Date: Jun. 22, 2006

(54) Method and apparatus for encoding video signal using previous picture already converted into H picture as reference picture of current picture and method and apparatus for decoding such encoded video signal

(76) Inventors: Seung Wook Park, Sungnam-si (KR); Ji Ho Park, Sungnam-si (KR); Byeong Moon Jeon, Sungnam-si (KR)

Correspondence Address: HARNESS, DICKEY & PIERCE, P.L.C., P.O. BOX 8910, RESTON, VA, 20195, US

(21) Appl. No.: 11/288,224

(22) Filed: Nov. 29, 2005

Related U.S. Application Data
(60) Provisional application No. 60/631,176, filed on Nov. 29, 2004.

(30) Foreign Application Priority Data
Feb. 25, 2005 (KR) 10-2005-0015968

(51) Int. Cl. H04N 11/02; H04N 11/04; H04N 7/12; H04B 1/66

(52) U.S. Cl. 375/240.16; 375/240.24

(57) ABSTRACT

A method and apparatus for encoding/decoding a video signal according to an MCTF coding scheme is provided. Not only pictures, which are to be converted into L pictures, but also pictures, which are to be converted into H pictures, at the current temporal decomposition level are used as candidates for a reference picture for coding a current picture into a predictive image. A previous picture, which has already been converted into an H picture, can also be used as a reference picture for converting the current picture into an H picture. Using the previous picture as the reference picture increases MCTF coding efficiency if the previous picture has an image most highly correlated with that of the current picture.

### BACKGROUND OF THE INVENTION

1. Field of the Invention

The present invention relates to scalable encoding and decoding of video signals, and more particularly to a method and apparatus for encoding a video signal according to a scalable Motion Compensated Temporal Filtering (MCTF) coding scheme, wherein a current picture in the video signal is coded into an error value by additionally using, as a candidate reference picture, a previous picture already coded into an error value, and a method and apparatus for decoding such encoded video data.

2. Description of the Related Art

It is difficult to allocate high bandwidth, required for TV signals, to digital video signals wirelessly transmitted and received by mobile phones and notebook computers, which are widely used, and by mobile TVs and handheld PCs, which it is believed will come into widespread use in the future. Thus, video compression standards for use with mobile devices must have high video signal compression efficiencies.

Such mobile devices have a variety of processing and presentation capabilities so that a variety of compressed video data forms must be prepared. This indicates that the same video source must be provided in a variety of forms corresponding to a variety of combinations of a number of variables such as the number of frames transmitted per second, resolution, and the number of bits per pixel. This imposes a great burden on content providers.

Because of these facts, content providers prepare high-bitrate compressed video data for each source video and perform, when receiving a request from a mobile device, a process of decoding compressed video and encoding it back into video data suited to the video processing capabilities of the mobile device before providing the requested video to the mobile device. However, this method entails a transcoding procedure including decoding and encoding processes, which causes some time delay in providing the requested data to the mobile device. The transcoding procedure also requires complex hardware and algorithms to cope with the wide variety of target encoding formats.

The Scalable Video Codec (SVC) has been developed in an attempt to overcome these problems. This scheme encodes video into a sequence of pictures with the highest image quality while ensuring that part of the encoded picture sequence (specifically, a partial sequence of frames intermittently selected from the total sequence of frames) can be decoded and used to represent the video with a low image quality. Motion Compensated Temporal Filtering (MCTF) is a scheme that has been suggested for use in the scalable video codec.

FIG. 1 illustrates a procedure for encoding a video signal according to a dyadic MCTF scheme in which alternating video frames selected from a given sequence of video frames are converted to H frames.

In FIG. 1, the video signal is composed of a sequence of pictures denoted by numbers. A prediction operation is performed for each odd picture with reference to adjacent even pictures to the left and right of the odd picture so that the odd picture is coded into an error value corresponding to image differences (also referred to as a “residual”) of the odd picture from the adjacent even pictures. In FIG. 1, each picture coded into an error value is marked ‘H’. The error value of the H picture is added to a reference picture used to obtain the error value. This operation is referred to as an update operation. In FIG. 1, each picture produced by the update operation is marked ‘L’. The prediction and update operations are performed for pictures (for example, pictures 1 to 16 in FIG. 1) in a given Group of Pictures (GOP), thereby obtaining 8 H pictures and 8 L pictures. The prediction and update operations are repeated for the 8 L pictures, thereby obtaining 4 H pictures and 4 L pictures. The prediction and update operations are repeated for the 4 L pictures. Such a procedure is referred to as temporal decomposition, and the Nth level of the temporal decomposition procedure is referred to as the Nth MCTF (or temporal decomposition) level, which will be referred to as level N for short.

All H pictures obtained by the prediction operations and an L picture 101 obtained by the update operation at the last level for the single GOP in the procedure of FIG. 1 are then transmitted.

FIG. 2 illustrates how pictures at a certain temporal decomposition level are encoded in the procedure of FIG. 1. In FIG. 2, a kth H picture of level N is obtained using, as reference pictures, some even L pictures of level N-1 (i.e., the level immediately prior to level N). For example, L pictures L_{N-1,0}, L_{N-1,2}, L_{N-1,4}, L_{N-1,6}, and L_{N-1,8} (indexed by 0, 2, 4, 6, 8) at level N-1 are used as candidate reference pictures to obtain a third H picture H_{N,2} at level N. Although arrows are drawn in FIG. 2 as if each odd L picture (L_{N-1,0} in this example) is converted into an H picture (H_{N,2}) with reference only to even L pictures (L_{N-1,4} and L_{N-1,6}) immediately adjacent to the odd L picture, other even L pictures (L_{N-1,0} and L_{N-1,2}) prior to the odd L picture (L_{N-1,5}) or other even L pictures (L_{N-1,8}) subsequent thereto can also be used as reference pictures of the odd L picture.

In the above MCTF scheme, as an L picture is more similar to a reference picture used to convert the L picture into an H picture, the H picture has a smaller error value, reducing the amount of coded information of the H picture. In the method illustrated in FIGS. 1 and 2, a k+1th H picture H_{N,k} of level N is obtained using, as candidate reference pictures, even L pictures L_{N-1,2i} (i: a positive integer within an appropriate range) temporally adjacent to the H picture H_{N,k}. One reason why odd L pictures L_{N-1,2m+1} are not used as candidate reference pictures for the H picture H_{N,k} is that odd L pictures L_{N-1,2m+1} (m<k) prior to the H picture H_{N,k} have already been converted into H pictures H_{N,j} (j=0,1, . . . , m).

However, if only even L pictures, which have not been converted into H pictures, are used as candidate reference pictures to convert a current odd L picture into an H picture as in the above MCTF scheme, the maximum coding efficiency cannot be achieved when blocks in an odd L picture are more similar to blocks in the current L picture than blocks in the even L pictures.

### SUMMARY OF THE INVENTION

Therefore, the present invention has been made in view of the above problems, and it is an object of the present invention to provide a method and apparatus for encoding a video signal in a scalable fashion, wherein a current picture in the video signal is coded into an error value to convert the current picture into a predictive image by additionally using, as a candidate reference picture, a previous picture already coded into an error value.

It is another object of the present invention to provide a method and apparatus for decoding a data stream including pictures, which have been coded into error values additionally using, as their reference pictures, pictures which have been previously coded into error values.

In accordance with the present invention, the above and other objects can be accomplished by the provision of a method and apparatus for encoding an input video frame sequence according to a scalable MCTF scheme while dividing the input video frame sequence into a first sub-sequence including frames, which are to be coded into error values, and a second sub-sequence including frames to which the error values are to be added, wherein a reference block of an image block included in an arbitrary frame belonging to the first sub-sequence is searched for in both a frame present in the second sub-sequence and a frame prior to the arbitrary frame and present in the first sub-sequence, and an image difference of the image block from the reference block is then obtained in the video frame sequence.

In an embodiment of the present invention, the first sub-sequence is either a set of odd frames or a set of even frames.

In an embodiment of the present invention, a plurality of odd frames temporally prior to the arbitrary frame are used as candidate reference frames so that reference blocks of image blocks in the arbitrary frame are searched for in the plurality of odd frames.

In an embodiment of the present invention, odd frames having original images are stored before the odd frames are coded into error values (or image differences) so that reference blocks of image blocks in subsequent odd frames are searched for in the stored odd frames

In an embodiment of the present invention, after a frame coded into an error value (or an image difference) is reconstructed to an original image in a decoding procedure, the reconstructed frame is stored, so that an area in the stored frame is used to reconstruct a block in a subsequent frame coded into an image difference if the area in the stored frame is specified as a reference block of the block in the subsequent frame.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates how a video signal is encoded according to an MCTF scheme;

FIG. 2 illustrates how pictures at a certain temporal decomposition level are encoded in the procedure of FIG. 1;

FIG. 3 is a block diagram of a video signal encoding apparatus to which a video signal coding method according to the present invention is applied;

FIG. 4 illustrates main elements of an MCTF encoder of FIG. 3 for performing image prediction/estimation and update operations;

FIG. 5 illustrates how a video signal is encoded according to an MCTF scheme at a certain temporal decomposition level according to the present invention;

FIG. 6 is a block diagram of an apparatus for decoding a data stream encoded by the apparatus of FIG. 3; and

FIG. 7 illustrates main elements of an MCTF decoder of FIG. 6 for performing inverse prediction and update operations.

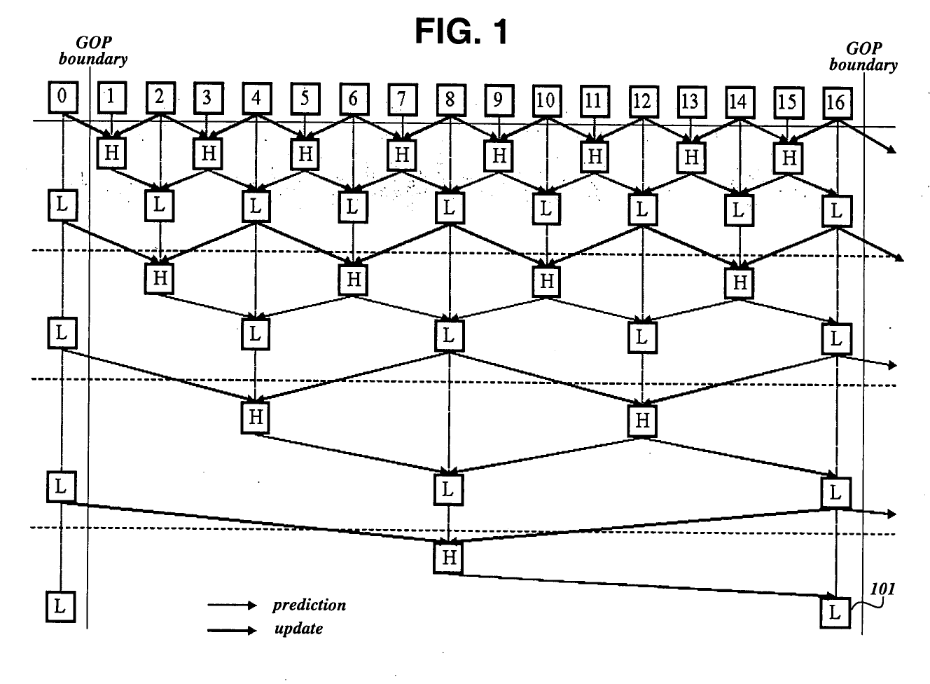

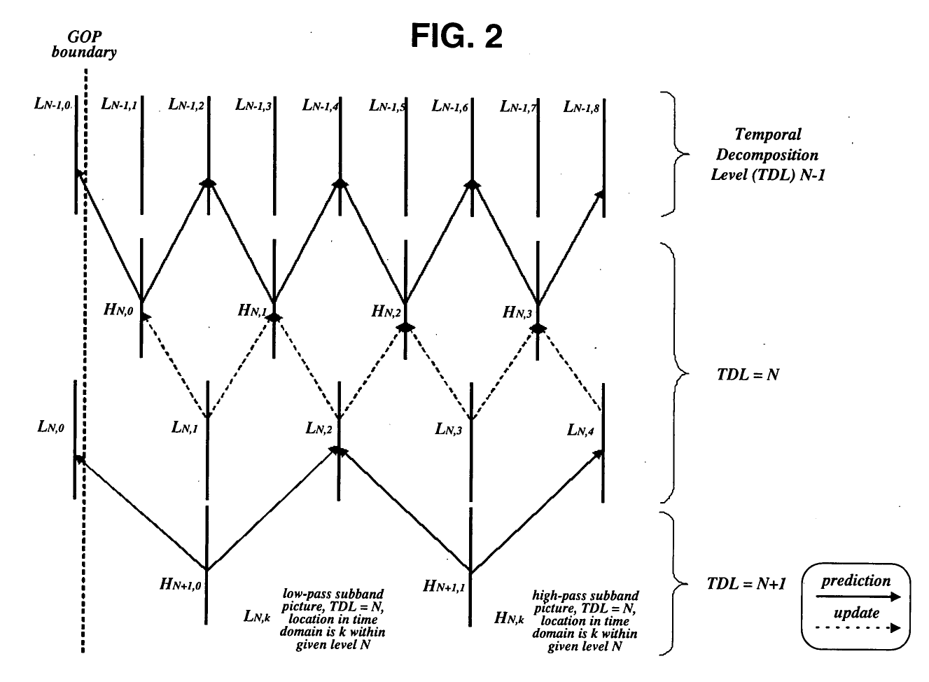

### DESCRIPTION OF THE PREFERRED EMBODIMENTS

Preferred embodiments of the present invention will now be described in detail with reference to the accompanying drawings.

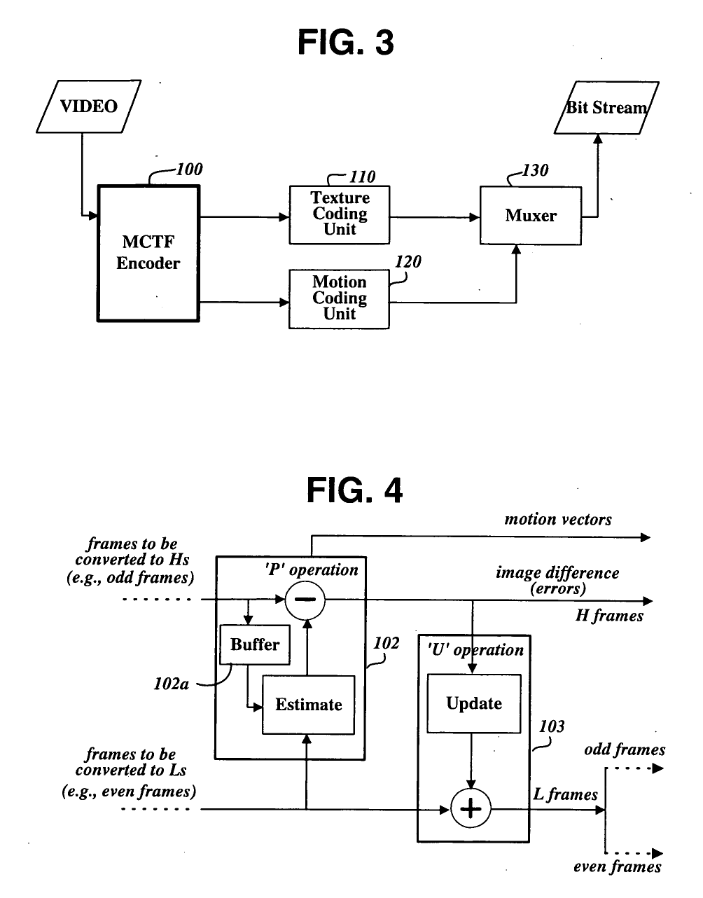

FIG. 3 is a block diagram of a video signal encoding apparatus to which a scalable video signal coding method according to the present invention is applied.

The video signal encoding apparatus shown in FIG. 3 comprises an MCTF encoder 100 to which the present invention is applied, a texture coding unit 110, a motion coding unit 120, and a muxer (or multiplexer) 130. The MCTF encoder 100 encodes an input video signal and generates suitable management information on a per macroblock basis according to an MCTF scheme. The texture coding unit 110 converts information of encoded macroblocks into a compressed bitstream. The motion coding unit 120 codes motion vectors of image blocks obtained by the MCTF encoder 100 into a compressed bitstream according to a specified scheme. The muxer 130 encapsulates the output data of the texture coding unit 110 and the output vector data of the motion coding unit 120 into a predetermined format. The muxer 130 then multiplexes and outputs the encapsulated data into a predetermined transmission format.

The MCTF encoder 100 performs motion estimation and prediction operations on each target macroblock in a video frame (or picture). The MCTF encoder 100 also performs an update operation by adding an image difference of the target macroblock from a reference macroblock in a reference frame to the reference macroblock. FIG. 4 illustrates main elements of the MCTF encoder 100 for performing these operations.

The MCTF encoder 100 separates an input video frame sequence into frames, which are to be coded into error values, and frames, to which the error values are to be added, and then performs estimation/prediction and update operations on the separated frames a plurality of times (over a plurality of temporal decomposition levels). FIG. 4 shows elements associated with estimation/prediction and update operations at one of the plurality of temporal decomposition levels. The elements of the MCTF encoder 100 shown in FIG. 4 are implemented using a dyadic scheme in which frames, which are to be coded into error values, are selected alternately from an input sequence of video frames. In the dyadic scheme, half of the frames of a GOP at a temporal decomposition level are coded into error values. MCTF may also employ various other methods for selecting frames to be coded into error values. For example, 2 frames to be coded into error values may be selected from 3 consecutive frames. Such methods are referred to as non-dyadic schemes.

Without being limited to specific methods for selecting frames to be coded into error values, the present invention is characterized in that a previous picture already coded into an error value is additionally used as a candidate reference frame for coding a current frame into an error value so that a reference block of each macroblock in the current frame is searched for also in the previous picture. Thus, it is natural that any embodiment employing the non-dyadic scheme, which is implemented using such a characteristic of the present invention, falls within the scope of the present invention.

The embodiment of the present invention will be described under the assumption that they employ the dyadic scheme in which frames to be coded into error values are selected alternately.

The elements of the MCTF encoder 100 shown in FIG. 4 include an estimator/predictor 102 and an updater 103. Through motion estimation, the estimator/predictor 102 searches for a reference block of each target macroblock of an odd (or even) frame, which is to be coded to residual data, in a neighbor frame prior to or subsequent to the odd (or even) frame. The estimator/predictor 102 then performs a prediction operation on the target macroblock in the odd (or even) frame by calculating both an image difference (i.e., a pixel-to-pixel difference) of the target macroblock from the reference block and a motion vector of the target macroblock with respect to the reference block. The updater 103 performs an update operation for a macroblock, whose reference block has been found in an even (or odd) frame by the motion estimation, by normalizing and adding the image difference of the macroblock to the reference block. The operation carried out by the updater 103 is referred to as a ‘U’ operation, and a frame produced by the ‘U’ operation is referred to as an ‘L’ frame. The ‘L’ frame is a low-pass subband picture. The estimator/predictor 102 includes a buffer 102a for buffering frames having original values of frames which have been coded into error values by the prediction operation.

The estimator/predictor 102 and the updater 103 of FIG. 4 may perform their operations on a plurality of slices, which are produced by dividing a single frame, simultaneously and in parallel instead of performing their operations on the video frame. A frame (or slice), which is produced by the estimator/predictor 102, is referred to as an ‘H’ frame (or slice). The difference value data in the ‘H’ frame (or slice) reflects high frequency components of the video signal. In the following description of the embodiments, the term ‘frame’ is used in a broad sense to include a ‘slice’, provided that replacement of the term ‘frame’ with the term ‘slice’ is technically equivalent.

More specifically, the estimator/predictor 102 divides each input odd video frame (or each odd L frame obtained at the previous level) into macroblocks of a predetermined size, and searches for a reference block having a most similar image to that of each divided macroblock in even and odd frames temporally prior to the input odd video frame and in even frames temporally subsequent thereto, and then produces a predictive image of the macroblock based on the reference block and obtains a motion vector of the divided macroblock with respect to the reference block.

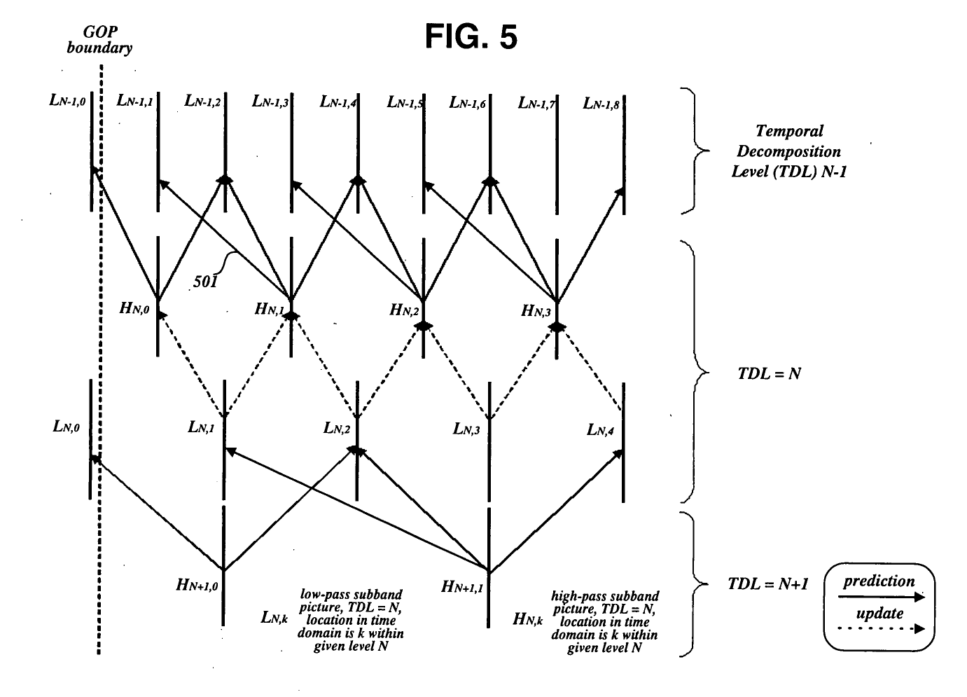

FIG. 5 illustrates how a video signal is encoded according to an MCTF scheme at a certain temporal decomposition level according to the present invention. The above procedure will now be described in detail with reference to FIG. 5.

The estimator/predictor 102 converts an odd L frame (for example, L_{N-1,1}) from among input L frames (or video frames) of level N-1 to an H frame H_{N,0} having a predictive image. For this conversion, the estimator/predictor 102 divides the odd L frame L_{N-1,1} into macroblocks, and searches for a macroblock, most highly correlated with each of the divided macroblocks, in L frames prior to and subsequent to the odd L frame L_{N-1,1} (for example, in an L frame L_{N-1,0} prior thereto and even frames L_{N-1,2} and L_{N-1,4} subsequent thereto). The block most highly correlated with a target block is a block having the smallest image difference from the target block. The image difference of two image blocks is defined, for example, as the sum or average of pixel-to-pixel differences of the two image blocks. Of blocks having a predetermined threshold pixel-to-pixel difference sum (or average) or less from the target block, a block(s) having the smallest difference sum (or average) is referred to as a reference block(s).

If a reference block is found, the estimator/predictor 102 obtains a motion vector originating from the target macroblock and extending to the reference block and transmits the motion vector to the motion coding unit 120. If one reference block is found in a frame, the estimator/predictor 101 calculates errors (i.e., differences) of pixel values of the target macroblock from pixel values of the reference block and codes the calculated errors into the target macroblock. If a plurality of reference blocks is found in a plurality of frames, the estimator/predictor 102 calculates errors (i.e., differences) of pixel values of the target macroblock from average pixel values of the reference blocks, and codes the calculated errors into the target macroblock. Then, the estimator/predictor 102 inserts a block mode value of the target macroblock according to the selected reference block (for example, one of the mode values of Skip, DirInv, Bid, Fwd, and Bwd modes) in a field at a specific position of a header of the target macroblock.

An H frame H_{N,0}, which is a predictive image of the odd L frame L_{N-1,1}, is completed upon completion of the above procedure for all macroblocks of the odd L frame L_{N-1,1}. This operation performed by the estimator/predictor 102 is referred to as a ‘P’ operation and a frame having an image difference (or residual) produced by the ‘P’ operation is referred to as an H frame, which is a high-pass subband picture.

In the meantime, the estimator/predictor 102 stores the odd L frame (L_{N-1,1}) in the internal buffer 102a before converting the odd L frame to a predictive image. The reason for storing the odd L frame in the buffer 102a is to use the stored odd L frame as a candidate reference frame when performing a prediction operation of a subsequent odd L frame. Specifically, when performing a predictor operation of a second odd L frame L_{N-1,3} for conversion into a predictive image, the estimator/predictor 102 searches for a reference block of each macroblock of the second odd L frame L_{N-1,3}, not only in even L frames L_{N-1,2i} (i=0,1,2, . . ) prior to and subsequent to the second odd L frame L_{N-1,3} but also in the first odd frame L_{N-1,1} stored in the buffer 102a as denoted by “501” in FIG. 5. That is, the stored odd frame L_{N-1,1} is used as a candidate reference frame of the second odd L frame L_{N-1,3}. More specifically, to produce an H frame H_{N,1}, the estimator/predictor 102 searches for a reference block of each macroblock of the second odd L frame L_{N-1,3} in an L frame L_{N-1,0}, the first odd L frame L_{N-1,1} stored in the buffer 102a, the prior even L frame L_{N-1,2}, and the subsequent even L frames L_{N-1,2i} (i=2,3,4, . . ). The estimator/predictor 102 then codes each macroblock of the second odd L frame L_{N-1,3} into an error value and obtains and outputs a motion vector of each macroblock with respect to the reference block. The second odd frame L_{N-1,3} is also stored in the buffer 102a before it is converted into a predictive image of the H frame H_{N,1}.

The buffer 102a has a predetermined size so as to maintain an appropriate number of frames stored in the buffer 102a. For example, the buffer 102a has a size of n frames if the estimator/predictor 102 is designed to use 2n frames prior to the current frame as candidate reference frames of the current frame. In this case, when a next frame is to be stored in the buffer 102a with n frames stored therein, the first stored one of the n frames is deleted from the buffer 102a and the next frame is then stored in the buffer 102a.

Due to the storage of odd L frames in the buffer 102a, the estimator/predictor 102 can use odd and even L frames L_{N-1,j} (j<2i+1) prior to a current odd L frame L_{N-1,2i+1} and even L frames L_{N-1,2k} (2k>2i+1) subsequent thereto as candidate reference frames for converting the current odd L frame L_{N-1,2i+1} into an H frame H_{N,i}, as illustrated in FIG. 5. Although arrows are drawn in FIG. 5 to avoid complicating the drawings as if only one odd frame prior to the current odd frame is added as a candidate reference frame of the current odd frame, a plurality of odd frames prior to the current odd frame can also be used as candidate reference frames of the current odd frame as described above.

The reason why odd frames subsequent to the current L frame are not used as candidate reference frames is that the decoder cannot use odd H frames subsequent to a given H frame as reference frames when reconstructing an original image of the given H frame since the subsequent odd H frames have not yet been reconstructed to their original images.

Then, the updater 103 performs an operation for adding an image difference of each macroblock of the current H frame to an L frame having a reference block of the macroblock as described above. If a macroblock in the current H frame (for example, H_{N,1}) has an error value which has been obtained using, as a reference block, a block in an odd L frame (for example, L_{N-1,1}) stored in the buffer 102a, the updater 103 does not perform the operation for adding the error value of the macroblock to the odd L frame.

A data stream encoded in the method described above is transmitted by wire or wirelessly to a decoding apparatus or is delivered via recording media. The decoding apparatus reconstructs an original video signal of the encoded data stream according to the method described below.

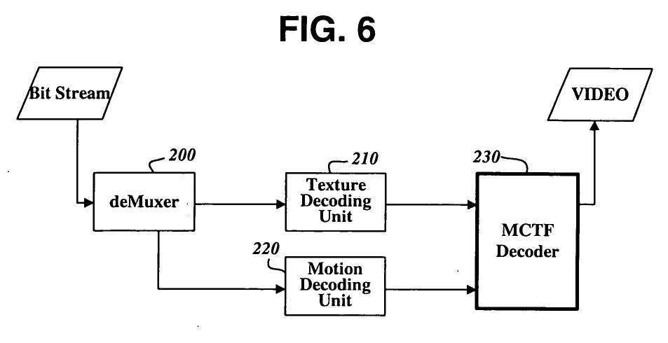

FIG. 6 is a block diagram of an apparatus for decoding a data stream encoded by the apparatus of FIG. 3. The decoding apparatus of FIG. 6 includes a demuxer (or demultiplexer) 200, a texture decoding unit 210, a motion decoding unit 220, and an MCTF decoder 230. The demuxer 200 separates a received data stream into a compressed motion vector stream and a compressed macroblock information stream. The texture decoding unit 210 reconstructs the compressed macroblock information stream to its original uncompressed state. The motion decoding unit 220 reconstructs the compressed motion vector stream to its original uncompressed state. The MCTF decoder 230 converts the uncompressed macroblock information stream and the uncompressed motion vector stream back to an original video signal according to an MCTF scheme.

The MCTF decoder 230 includes elements for reconstructing an original frame sequence from an input stream.

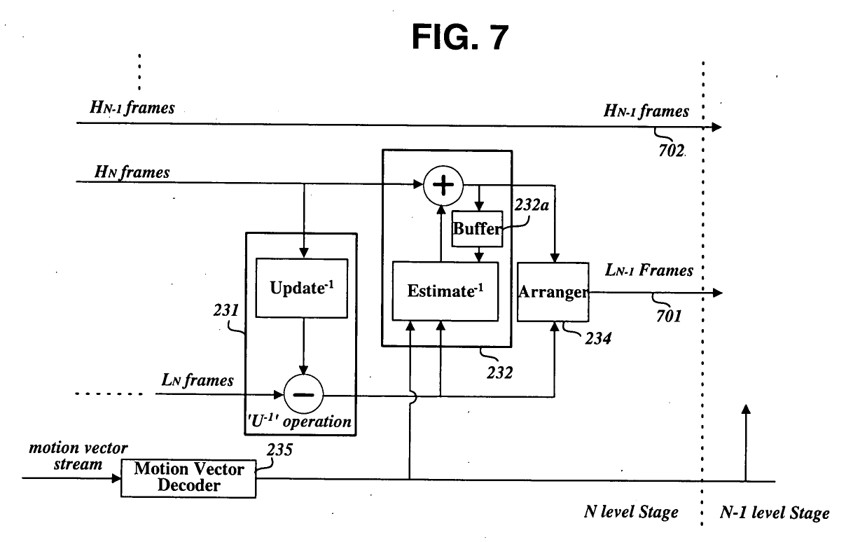

FIG. 7 illustrates main elements of the MCTF decoder 230 responsible for reconstructing a sequence of H and L frames of level N to an L frame sequence of level N-1. The elements of the MCTF decoder 230 shown in FIG. 7 include an inverse updater 231, an inverse predictor 232, a motion vector decoder 235, and an arranger 234. The inverse updater 231 selectively subtracts pixel difference values of input H frames from pixel values of input L frames. The inverse predictor 232 reconstructs input H frames to L frames having original images using the H frames and the L frames, from which the image differences of the H frames have been subtracted. The motion vector decoder 235 decodes an input motion vector stream into motion vector information of blocks in H frames and provides the motion vector information to an inverse predictor (for example, the inverse predictor 232) of each stage. The arranger 234 interleaves the L frames completed by the inverse predictor 232 between the L frames output from the inverse updater 231, thereby producing a normal sequence of L frames. The inverse predictor 232 includes a buffer 232a for buffering a predetermined number of L frames having original images into which H frames have been converted.

L frames output from the arranger 234 constitute an L frame sequence 701 of level N-1. A next-stage inverse updater and predictor of level N-1 reconstructs the L frame sequence 701 and an input H frame sequence 702 of level N-1 to an L frame sequence. This decoding process is performed the same number of times as the number of MCTF levels employed in the encoding procedure, thereby reconstructing an original video frame sequence.

A more detailed description will now be given of how H frames of level N are reconstructed to L frames according to the present invention. First, for an input L frame, the inverse updater 231 performs an operation for subtracting error values (i.e., image differences) of macroblocks in all H frames, whose image differences have been obtained using blocks in the L frame as reference blocks, from the blocks of the L frame. When a macroblock in an H frame (for example, H_{N,1}) has an image difference which has been obtained with reference to a block in an odd L frame (for example, an odd L frame L_{N-1,1} stored in the buffer 102a) as described above in the encoding procedure, the inverse updater 231 does not perform the operation for subtracting the image difference of the macroblock from the odd L frame since the odd L frame is received as an H frame at the same MCTF level.

For each macroblock in a current H frame, the inverse predictor 232 locates a reference block of the macroblock in an L frame (which may include an L frame output from the inverse updater 231 or an L frame having an original image stored in the buffer 232a which has already been reconstructed from a previous H frame) with reference to a motion vector provided from the motion vector decoder 235, and reconstructs an original image of the macroblock by adding pixel values of the reference block to difference values of pixels of the macroblock. Such a procedure is performed for all macroblocks in the current H frame to reconstruct the current H frame to an L frame. The reconstructed L frame is stored in the buffer 232a and is also provided to the next stage through the arranger 234.

If each frame of the video signal has been encoded using n odd frames prior to the frame as candidate reference frames as described above in the encoding procedure, the buffer 232a in the inverse predictor 232 is implemented to have a size of n L frames and thus to buffer n L frames reconstructed recently so that the stored n L frames can be used as candidate reference frames of a next H frame.

The above decoding method reconstructs an MCTF-encoded data stream to a complete video frame sequence. In the case where the estimation/prediction and update operations have been performed on a GOP P times in the MCTF encoding procedure described above, a video frame sequence with the original image quality is obtained if the inverse prediction and update operations are performed P times, whereas a video frame sequence with a lower image quality and at a lower bitrate is obtained if the inverse prediction and update operations are performed less than P times. Accordingly, the decoding apparatus is designed to perform inverse prediction and update operations to the extent suitable for the performance thereof.

The decoding apparatus described above can be incorporated into a mobile communication terminal, a media player, or the like.

As is apparent from the above description, the present invention provides a method and apparatus for encoding/decoding a video signal according to an MCTF scheme, wherein a previous frame already converted into an H frame can also be used as a reference frame for converting a current frame into an H frame. If the previous picture has an image most highly correlated with that of the current picture, use of the previous picture as the reference frame decreases the image difference of the converted H frame of the current picture, and thus reduces the amount of coded data of the current frame, thereby increasing MCTF coding efficiency.

Although this invention has been described with reference to the preferred embodiments, it will be apparent to those skilled in the art that various improvements, modifications, replacements, and additions can be made in the invention without departing from the scope and spirit of the invention. Thus, it is intended that the invention cover the improvements, modifications, replacements, and additions of the invention, provided they come within the scope of the appended claims and their equivalents.

What is claimed is:

1. An apparatus for encoding a video frame sequence divided into a first sub-sequence including frames, which are to be coded into error values, and a second sub-sequence including frames to which the error values are to be added, the apparatus comprising:
first means for searching for a reference block of an image block included in an arbitrary frame belonging to the first sub-sequence in both a frame present in the second sub-sequence and a frame prior to the arbitrary frame and present in the first sub-sequence, coding an image difference between the image block and the reference block into the image block, and obtaining a motion vector of the image block with respect to the reference block; and
second means for selectively performing an operation for adding the image difference between the image block and the reference block to the reference block.

2. The apparatus according to claim 1, wherein the reference block includes a block having the smallest image difference value from the image block from among a plurality of blocks having a predetermined threshold difference value or less from the image block.

3. The apparatus according to claim 1, wherein the first means includes storage means for storing a frame having an original image of the arbitrary frame before image blocks in the arbitrary frame are coded into image differences, and
wherein a reference block of an image block in a frame belonging to the first sub-sequence subsequent to the arbitrary frame is searched for in the frame stored in the storage means.

4. The apparatus according to claim 1, wherein the first means searches for the reference block of the image block in a plurality of frames in the second sub-sequence and a plurality of frames in the first sub-sequence temporally prior to the arbitrary frame.

5. The apparatus according to claim 1, wherein, if the reference block is found in a frame belonging to the second sub-sequence, the second means performs the operation for adding the image difference between the image block and the reference block to the reference block.

6. The apparatus according to claim 1, wherein, if the reference block is found in a frame belonging to the first sub-sequence, the second means does not perform the operation for adding the image difference between the image block and the reference block to the reference block.

7. The apparatus according to claim 1, wherein the first sub-sequence is either a set of odd frames or a set of even frames in the video frame sequence.

8. The apparatus according to claim 1, wherein the first sub-sequence sequence and the second sub-sequence belong to the same temporal decomposition level.

9. The apparatus according to claim 1, wherein the frame prior to the arbitrary frame and present in the first sub-sequence is coded into an error value before the arbitrary frame is coded into an error value.

10. The apparatus according to claim 9, wherein the first means searches for the reference block of the image block in a picture of the frame prior to the arbitrary frame and present in the first sub-sequence, the picture of the frame being stored before the frame prior to the arbitrary frame is coded into an error value.

11. A method for encoding a video frame sequence divided into a first sub-sequence including frames, which are to be coded into error values, and a second sub-sequence including frames to which the error values are to be added, the method comprising the steps of:
a) searching for a reference block of an image block included in an arbitrary frame belonging to the first sub-sequence in both a frame present in the second sub-sequence and a frame prior to the arbitrary frame and present in the first sub-sequence, coding an image difference between the image block and the reference block into the image block, and obtaining a motion vector of the image block with respect to the reference block; and
b) selectively performing an operation for adding the image difference between the image block and the reference block to the reference block.

12. The method according to claim 11, wherein the reference block includes a block having the smallest image difference value from the image block from among a plurality of blocks having a predetermined threshold difference value or less from the image block.

13. The method according to claim 11, wherein the step a) includes storing a frame having an original image of the arbitrary frame before image blocks in the arbitrary frame are coded into image differences so that a reference block of an image block in a frame belonging to the first sub-sequence subsequent to the arbitrary frame is searched for in the stored frame.

14. The method according to claim 11, wherein the step a) includes searching for the reference block of the image block in a plurality of frames in the second sub-sequence and a plurality of frames in the first sub-sequence temporally prior to the arbitrary frame.

15. The method according to claim 11, wherein, at the step b), the operation for adding the image difference between the image block and the reference block to the reference block is performed if the reference block is found in a frame belonging to the second sub-sequence.

16. The method according to claim 11, wherein, at the step b), the operation for adding the image difference between the image block and the reference block to the reference block is not performed if the reference block is found in a frame belonging to the first sub-sequence.

17. The method according to claim 11, wherein the first sub-sequence is either a set of odd frames or a set of even frames in the video frame sequence.

18. The method according to claim 11, wherein the first sub-sequence sequence and the second sub-sequence belong to the same temporal decomposition level.

19. The method according to claim 11, wherein the frame prior to the arbitrary frame and present in the first sub-sequence is coded into an error value before the arbitrary frame is coded into an error value.

20. The method according to claim 19, wherein the step a) includes searching for the reference block of the image block in a picture of the frame prior to the arbitrary frame and present in the first sub-sequence, the picture of the frame being stored before the frame prior to the arbitrary frame is coded into an error value.

21. An apparatus for receiving and decoding a first sequence of frames, each including pixels having difference values, and a second sequence of frames into a video signal, the apparatus comprising:
first means for subtracting difference values of pixels in a target block present in a frame belonging to the first frame sequence from a reference block, based on which the difference values of the pixels in the target block have been obtained, if the reference block is present in a frame belonging to the second frame sequence; and
second means for reconstructing the difference values of the pixels in the target block to an original image of the target block using pixel values of a reference block present in a frame belonging to the second frame sequence or in a frame having an original image reconstructed from a frame including pixels having difference values and belonging to the first frame sequence.

22. The apparatus according to claim 21, wherein the second means specifies the reference block of the target block based on information of a motion vector of the block.

23. The apparatus according to claim 21, wherein the second means includes storage means for storing a frame belonging to the first frame sequence and including blocks whose original images have been reconstructed from image differences,
wherein the second means reconstructs an original image of a first block in a frame belonging to the first frame sequence subsequent to an arbitrary frame stored in the storage means using pixel values of an area in the arbitrary frame if the area in the arbitrary frame is specified as a reference block of the first block.

24. The apparatus according to claim 21, wherein frames belonging to the first frame sequence and frames belonging to the second frame sequence are alternately arranged to constitute a frame sequence.

25. The apparatus according to claim 21, wherein the first frame sequence and the second frame sequence belong to the same temporal decomposition level.

26. A method for receiving and decoding a first sequence of frames, each including pixels having difference values, and a second sequence of frames into a video signal, the method comprising the steps of:
a) subtracting difference values of pixels in a target block present in a frame belonging to the first frame sequence from a reference block, based on which the difference values of the pixels in the target block have been obtained, if the reference block is present in a frame belonging to the second frame sequence; and
b) reconstructing the difference values of the pixels in the target block to an original image of the target block using pixel values of a reference block present in a frame belonging to the second frame sequence or in a frame having an original image reconstructed from a frame including pixels having difference values and belonging to the first frame sequence.

27. The method according to claim 26, wherein the step b) includes specifying the reference block of the target block based on information of a motion vector of the block.

28. The method according to claim 26, wherein the step b) includes:
storing a frame belonging to the first frame sequence and including blocks whose original images have been reconstructed from image differences; and
reconstructing an original image of a first block in a frame belonging to the first frame sequence subsequent to the stored frame using pixel values of an area in the stored frame if the area in the stored frame is specified as a reference block of the first block.

29. The method according to claim 26, wherein frames belonging to the first frame sequence and frames belonging to the second frame sequence are alternately arranged to constitute a frame sequence.

30. The method according to claim 26, wherein the first frame sequence and the second frame sequence belong to the same temporal decomposition level.
